(19) United States
(12) Patent Application Publication
(10) Pub. No.: US 2017/0287451 A1
(43) Pub. Date: Oct. 5, 2017

(54) LAYERED PICK

(71) Applicant: David Andrew Novak, Newbury, OH (US)

(72) Inventor: David Andrew Novak, Newbury, OH (US)

(21) Appl. No.: 15/479,234

(22) Filed: Apr. 4, 2017

Related U.S. Application Data
(60) Provisional application No. 62/317,840, filed on Apr. 4, 2016.

(51) Int. Cl. G10D 3/16

(52) U.S. Cl. CPC G10D 3/163

(57) ABSTRACT

A plectrum or pick for a stringed musical instrument. The plectrum includes a core and at least one outer layer. The core is made of a rigid material and has a front surface opposite a rear surface. The outer layer is made of a soft material. The outer layer is attached to one of the front surface and the rear surface.

### CROSS-REFERENCE TO RELATED APPLICATION

This application claims the benefit of priority of U.S. provisional application number 62/317,840, filed Apr. 4, 2016, the contents of which are herein incorporated by reference.

### BACKGROUND OF THE INVENTION

The present invention relates to picks for musical instruments and, more particularly, to a leather pick.

Playing with an ordinary, plastic pick produces an unnatural slapping tone that is harsh and sharp. If a musician wants the natural tone of skin, he or she must use their fingers to pluck the strings. Some musicians find it difficult to use their fingers to play the instrument. They are forced to use a plastic pick to produce notes on the instrument, which in turn produces the unnatural tone of plastic on the strings. Other organic substitutes, such as felt, soften the tone, but they do not replicate the sound of skin, and they are also flimsy and lose their shape very quickly.

As can be seen, there is a need for an improved pick that provides a natural sound.

### SUMMARY OF THE INVENTION

In one aspect of the present invention, a plectrum comprises: a core comprising a rigid material having a front surface opposite a rear surface, wherein the core comprises a triangular shape; and at least one leather layer attached to one of the front surface and the rear surface.

In another aspect of the present invention, a plectrum comprises: a core comprising a rigid material having a front surface opposite a rear surface, wherein the core comprises a triangular shape; and at least one outer layer comprising a soft material, wherein the at least one outer layer is attached to one of the front surface and the rear surface.

In another aspect of the present invention, a plectrum comprises: a core comprising a rigid material having a front surface opposite a rear surface; a first leather layer attached to the front surface; and a second leather layer attached to the rear surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a top view of an embodiment of the present invention;

FIG. 3 is a section view of an embodiment of the present invention taken along line 3-3 in FIG. 1;

FIG. 4 is a perspective view of an embodiment of the present invention;

FIG. 5 is a top view of an embodiment of the present invention; and

FIG. 6 is a section view of an embodiment of the present invention taken along line 6-6 in FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a plastic pick covered in leather, used by bass and guitar players and other stringed instrument musicians, to emulate the tone of natural skin. The present invention encloses a plastic pick with an outer leather covering, allowing the musician to achieve the tone of the finger's skin in the same familiar and comfortable way as a plastic pick.

The present invention is different from the standard pick because it uses leather to emulate the sound of skin. This makes it better than standard picks because it produces a more real and natural tone. It also exceeds any organic substitute such as wool or felt, because it is actually made of skin.

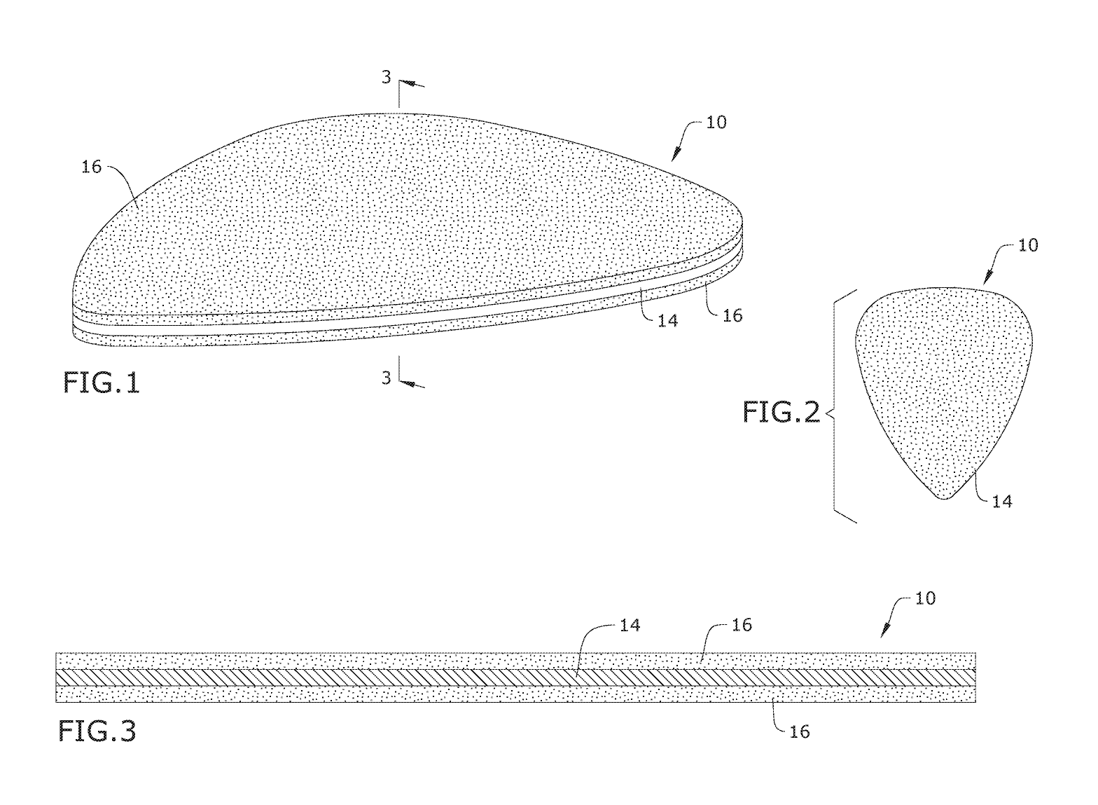

Referring to FIGS. 1 through 6, the present invention includes a plectrum 10 or pick for a stringed musical instrument. The plectrum 10 includes a core 14 and at least one outer layer 16. The core 14 is made of a rigid material and has a front surface opposite a rear surface. The outer layer 16 is made of a soft material. The outer layer 16 is attached to one of the front surface and the rear surface.

As illustrated in the Figures, the at least one outer layer 16 may include a first outer layer 16 attached to the front surface and a second outer layer 16 attached to the rear surface.

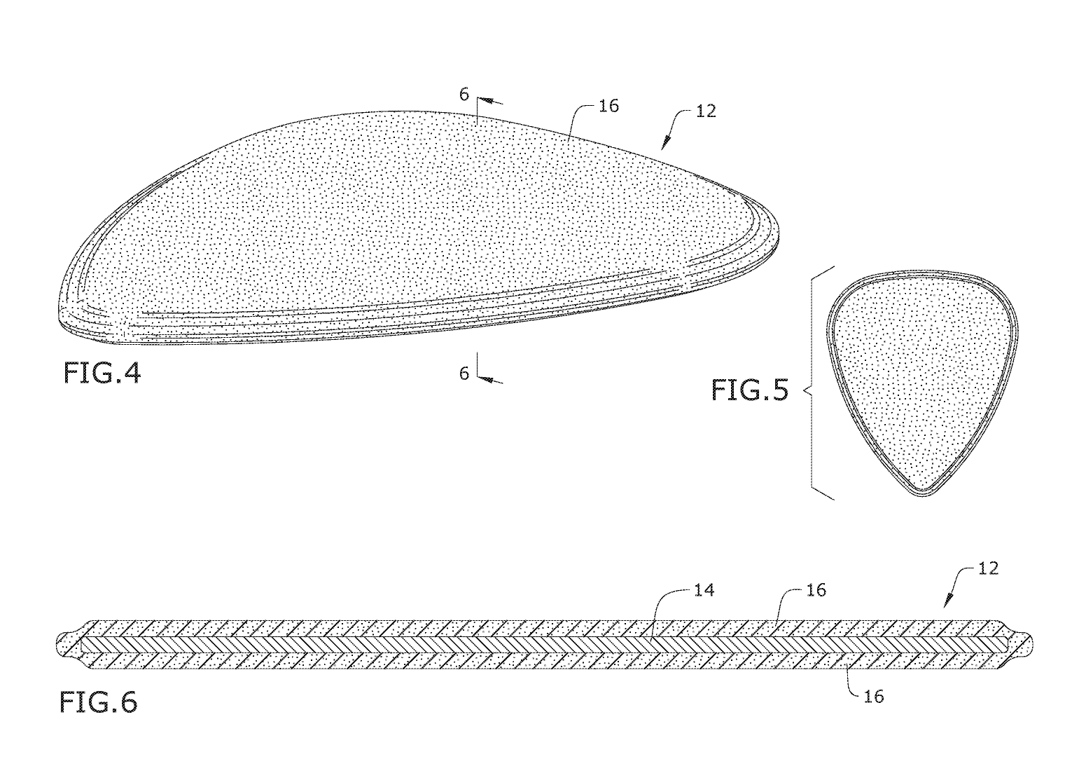

As illustrated in FIG. 4, a plectrum 12 of the present invention may include an outer edge layer. The outer edge layer may be made of the same soft material as the first outer layer 16 and the second outer layer 16. The outer edge layer connects the first and second outer layers 16 together, thereby encasing the core 14 therebetween.

The core 14 of the present invention gives it size, shape, and flexibility. The core 14 may include a rigid material including plastics (Celluloid, Nylon, Acetal, Ultem, Lexan, Acrylic, Delrex, Tortex, Delrin, celluloid), rubber, felt, tortoiseshell, wood, metal, glass, tagua, stone, agate, carbon fiber, fiberglass, cardboard, new tortis, and PHD. The shape of the core 14 may be triangular, such as an acute isosceles triangle with or without the two equal corners rounded and the third corner less rounded, square with or without the corners rounded, rectangular with or without the corners rounded, circle, ellipse, equilateral triangle with or without the two equal corners rounded and the third corner less rounded, isosceles triangle with or without the two equal corners rounded and the third corner less rounded, scalene triangle with or without the two equal corners rounded and the third corner less rounded, right triangle with or without the corners rounded and the third corner less rounded, rhombus with or without the corners rounded, parallelogram with or without the corners rounded, trapezoid with or without the corners rounded, a diamond shape with or without the corners rounded, a pentagram with or without the corners rounded, a hexagon with or without the corners rounded, an octagon with or without the corners rounded, a decagon with or without the corners rounded, a standard, teardrop, jazz or sharkfin shape. The thickness of the core 14 could range from about 0.01 mm to about 3.00 mm, such as from about 0.10 mm to about 2.5 mm. The height of the core 14 can range from about 5.00 mm to about 55.00 mm, such as from about 15.00 mm to about 50.00 mm. The width of the core 14 can range from about 10.00 mm to about 50.00 mm, such as from about 15.00 mm to about 35.5 mm.

The outer layers 16 mimic the sound of skin. The outer layers 16 may include bovine or cowhide leather, pig or hog skin leather, goat skin leather, sheep skin leather, deerskin, bison or buffalo skin, ostrich leather, kangaroo leather, crocodile and alligator skin, snakeskin, eel skin, stingray or shagreen leather, shark skin, boar skin, elk skin, horse skin, mule skin, donkey skin, ox skin, seal skin, walrus skin, whale skin, lizard skin, yak skin, rabbit skin, squirrel skin, synthetic skin, rubber, felt, waxed or oiled canvas, wool and animal fur. The outer layers 16 may be adhered to the core 14 and may fully cover the 14 or partially cover the core 14. The height of the outer layers 16 can range from about 5.00 mm to about 55.00 mm, such as from about 15.00 mm to about 50.00 mm. The width of outer layers 16 can range from about 10.00 mm to about 50.00 mm, such as from about 15.00 mm to about 35.5 mm.

The core 14 may be encased completely in the outer layers 16 using an adhesive. Other configurations could include the outer layers 16 being partially applied to the core 14, such as just on the tip that strikes the strings. The outer layers 16 could also potentially be applied in strips, or in “polka-dots” on the core 14. The outer layers 16 could also be applied to just the edges of the core 14 or only on one side. The outer layer 16 produces a sound that is similar to the skin on the human finger. When the core 14 and the outer layer 16 are combined, the present invention produces a plectrum 10 which feels and plays similar to an ordinary pick, but with the sound of real skin, giving it a totally natural and unique sound.

A person may manufacture the present invention by first stamping, cutting, sawing, or using computer numeric controlled routers to shape the form of the core 14. The outer layers 16 may be adhered to the outer surfaces of the core 14 creating a laminate. The laminate may include a first outer layer 16, the core 14 and then the second outer layer 16.

Alternatively, the plectrum 10 may be shaped after the outer layers 16 have been adhered to the core 14. Once the laminate has been created it is placed in a vacuum form for shaping and curing. Once the shaping and curing is complete, each individual form is then punched out using a die and press.

It should be understood, of course, that the foregoing relates to exemplary embodiments of the invention and that modifications may be made without departing from the spirit and scope of the invention as set forth in the following claims.

What is claimed is:

1. A plectrum comprising:
a core comprising a rigid material having a front surface opposite a rear surface, wherein the core comprises a triangular shape; and
at least one leather layer attached to one of the front surface and the rear surface.

2. The plectrum of claim 1, wherein the at least one leather layer comprises a first leather layer attached to the front surface and a second leather layer attached to the rear surface.

3. The plectrum of claim 1, wherein corners of the core and the at least one leather layer are rounded.

4. The plectrum of claim 1, further comprising a leather outer edge connecting the first leather layer and the second leather layer, and thereby encasing the core therebetween.

5. The plectrum of claim 1, wherein the core is plastic.

6. A plectrum comprising:
a core comprising a rigid material having a front surface opposite a rear surface, wherein the core comprises a triangular shape; and
at least one outer layer comprising a soft material, wherein the at least one outer layer is attached to one of the front surface and the rear surface.

7. The plectrum of claim 6, wherein the soft material comprises an animal skin.

8. The plectrum of claim 7, wherein the animal skin is leather.

9. The plectrum of claim 6, wherein the at least one outer layer comprises a first outer layer attached to the front surface and a second outer layer attached to the rear surface.

10. The plectrum of claim 9, further comprising an outer edge layer comprising the soft material and connecting the first outer layer and the second outer layer, and thereby encasing the core therebetween.

11. The plectrum of claim 6, wherein corners of the core and the soft material are rounded.

12. The plectrum of claim 6, wherein the core is plastic.

13. A plectrum comprising:
a core comprising a rigid material having a front surface opposite a rear surface;
a first leather layer attached to the front surface; and
a second leather layer attached to the rear surface.

14. The plectrum of claim 13, further comprising a leather outer edge connecting the first leather layer and the second leather layer, and thereby encasing the core therebetween.
